(19) United States
(12) Patent Application Publication
(10) Pub. No.: US 2025/0379803 A1
(43) Pub. Date: Dec. 11, 2025

(54) AI-ASSISTED IMPACTED USER INFERENCE IN PROACTIVE CARE FOR CELLULAR / IOT SERVICE ISSUES

(71) Applicants: AT&T Intellectual Property I, L.P., Atlanta, GA (US); Purdue Research Foundation, West Lafayette, IN (US)

(72) Inventors: Xiaofeng Shi, Vernon, CT (US); Jia Wang, Basking Ridge, NJ (US); Amit Kumar Sheoran, Raritan, NJ (US); Yanbing Liu, West Lafayette, IN (US); Chunyi Peng, West Lafayette, IN (US)

(73) Assignees: AT&T Intellectual Property I, L.P., Atlanta, GA (US); Purdue Research Foundation, West Lafayette, IN (US)

(21) Appl. No.: 18/734,970

(22) Filed: Jun. 5, 2024

(51) Int. Cl. H04L 41/5074; H04L 41/0654; H04L 41/5009

(52) U.S. Cl. CPC H04L 41/5074; H04L 41/0654; H04L 41/5009

(57) ABSTRACT

Aspects of the subject disclosure may include, for example, receiving outage data about service issues including a service outage in a mobility network, the service outage affecting a plurality of affected users of the mobility network, the plurality of affected users including reported users, identifying, in the outage data, patterns about the reported users, and inferring impacted users of the mobility network based on the patterns about the reported users, the impacted users including users who experienced the service outage but did not report the service outage. Other embodiments are disclosed.

### FIELD OF THE DISCLOSURE

The subject disclosure relates to inferring mobile and internet of things (IoT) users who are impacted by cellular network outages based on user equipment service performance profiling and machine learning.

### BACKGROUND

Network outages occur from time to time in cellular networks and other mobility networks. Identifying users and user equipment affected by such outages is important for mitigating a current issue causing an outage and predicting future issues to prevent or limit future outages.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 2C includes graphs showing a comparison of selected key performance indicators observed with reported users and normal users from three days before outage to three days after outage occurring in a cellular network.

FIG. 2D shows statistics between different user groups and different periods for an outage in a cellular network.

FIG. 2E shows the ranking of each key performance indicator in each outage instance in a cellular network based on F-statistics.

FIG. 2F shows selected key performance indicators of impacted and unimpacted users after a network outage through report or inference.

FIG. 2G illustrates short term user impact due to an outage in a cellular network.

FIG. 2H illustrates user impact for a disconnected user during an outage in a cellular network.

FIG. 2I illustrates indirectly impacted users during an outage in a cellular network.

FIG. 2J illustrates statistical results in example outage events between different groups and periods during an outage in a cellular network.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for inferring silent users of a mobility network who experience a service outage but do not report the service outage. Information about other reported users who do report the outage is used to train an inference model to identify the silent users. A set of critical key performance indicators is identified among data about the service outage based on patterns of reported users in cases of service outages. Other embodiments are described in the subject disclosure.

One or more aspects of the subject disclosure include receiving outage data about service issues including a service outage in a mobility network, the service outage affecting a plurality of affected users of the mobility network, the plurality of affected users including reported users, identifying, in the outage data, patterns about the reported users, and inferring impacted users of the mobility network based on the patterns about the reported users, the impacted users including users who experienced the service outage but did not report the service outage.

One or more aspects of the subject disclosure include receiving outage data related to service issues including a service outage in a mobility network, the service outage affecting a plurality of affected users of the mobility network, the plurality of affected users including reported users known to be affected by the service outage, identifying, in the outage data, critical key performance indicators (KPIs) associated with the service outage, identifying, in the outage data, silent users not impacted by the outage, forming a silent user dataset, building a model based on the critical KPIs, applying the silent user dataset to the model, and inferring impacted users based on output of the model, the impacted users including users of the mobility network who experienced the service outage but did not report the service outage.

One or more aspects of the subject disclosure include receiving outage data related to service issues including a service outage in a mobility network, the service outage affecting a plurality of affected users of the mobility network, the plurality of affected users including reported users known to be affected by the service outage, identifying in the outage data, critical key performance indicators (KPIs) associated with the service outage, building an inference model based on the critical KPIs, and inferring silent users based on output of the inference model, the silent users including affected users who are not reported users.

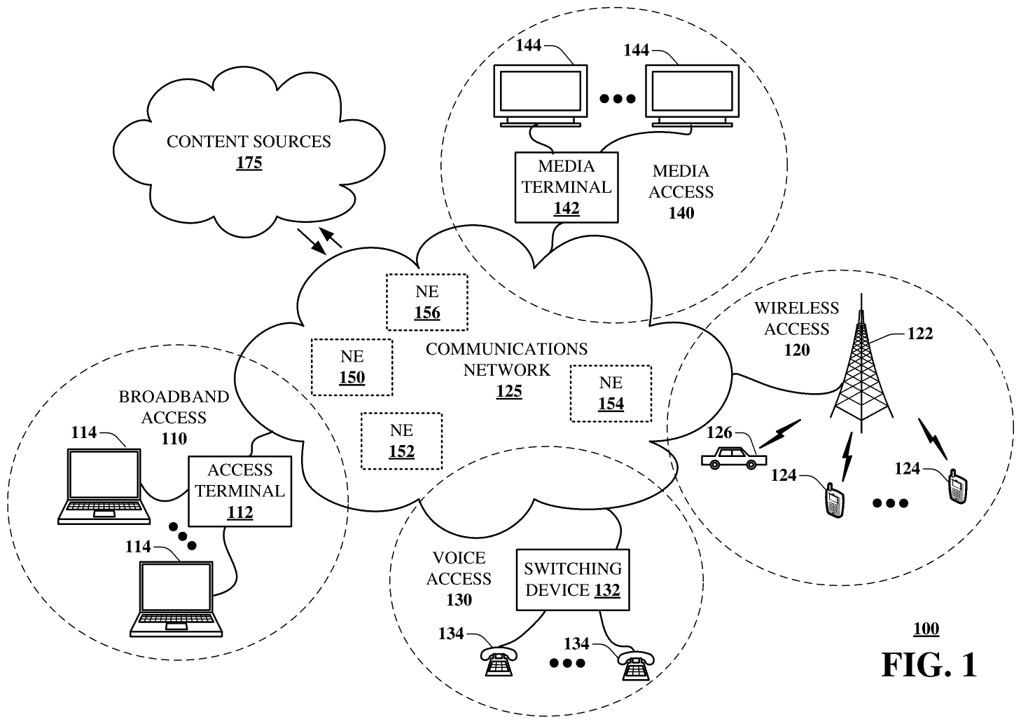

Referring now to FIG. 1, a block diagram is shown illustrating an example, non-limiting embodiment of a system 100 in accordance with various aspects described herein. For example, system 100 can facilitate in whole or in part collecting outage data for a network service outage and inferring users who do not report the service outage based on information about reported users who do report the service outage. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

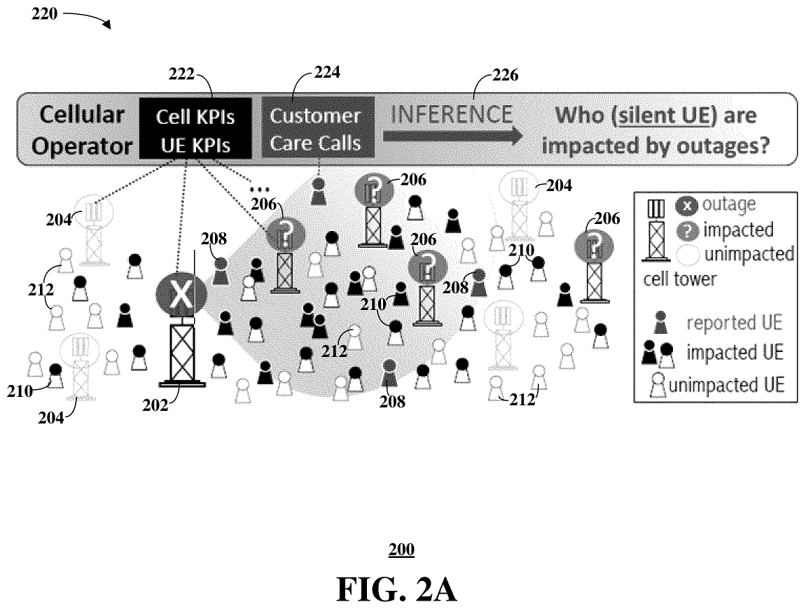

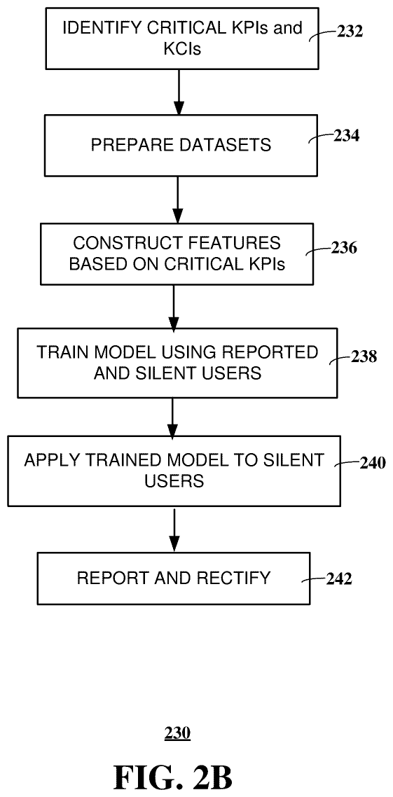

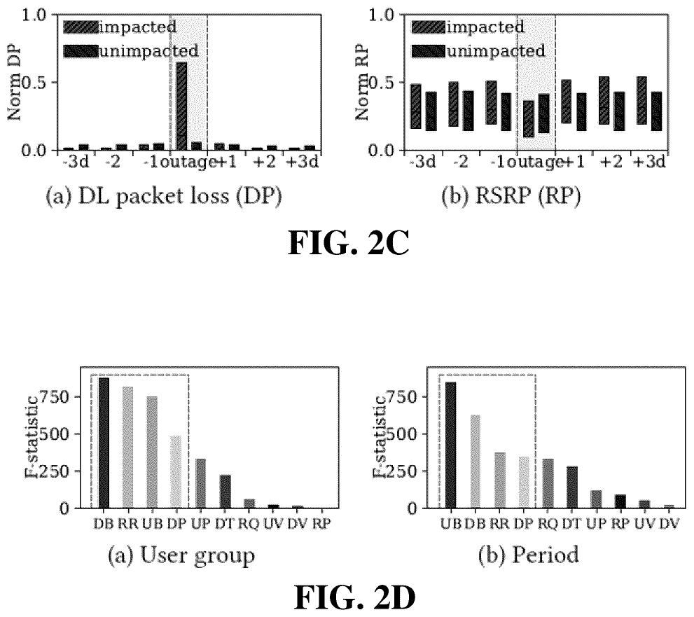

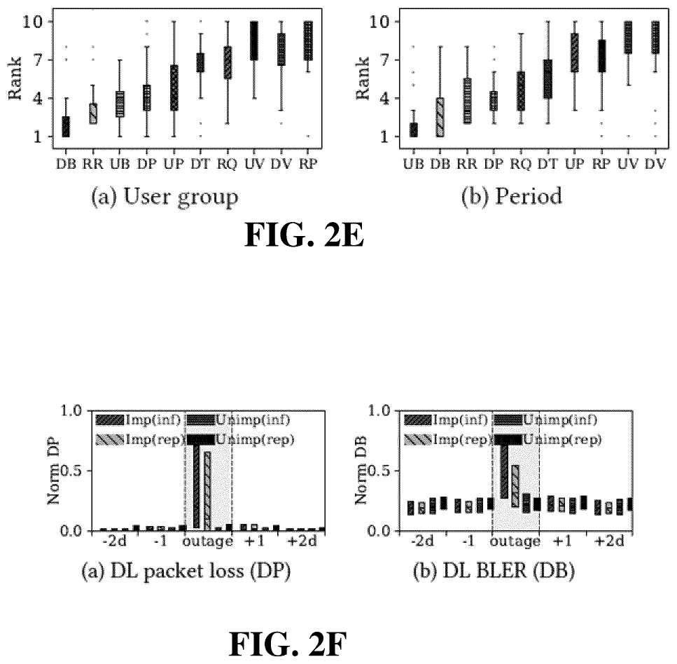

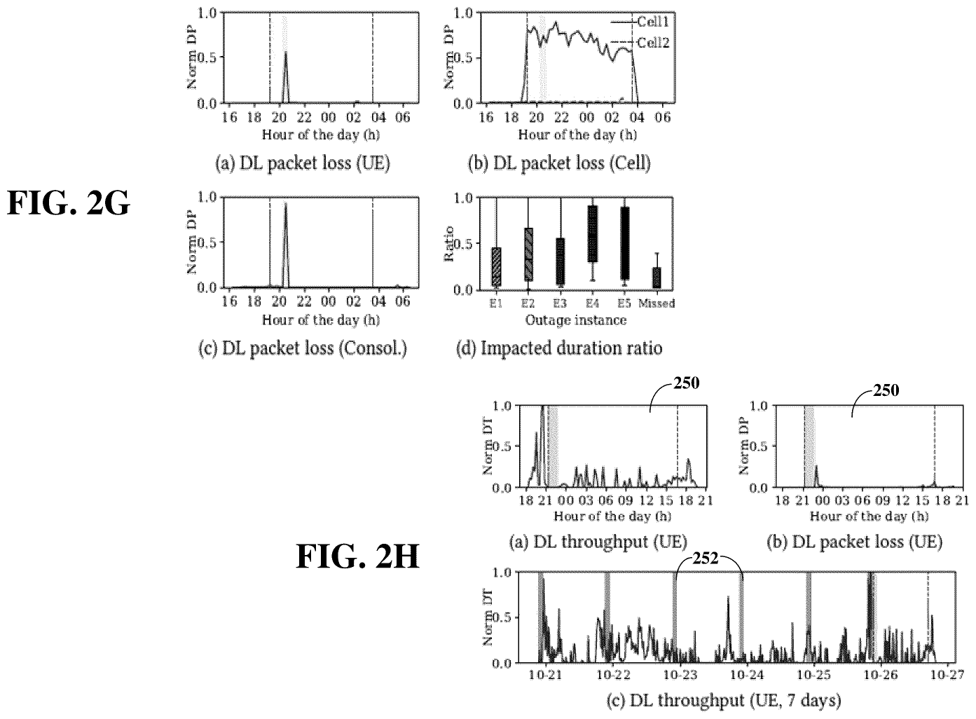

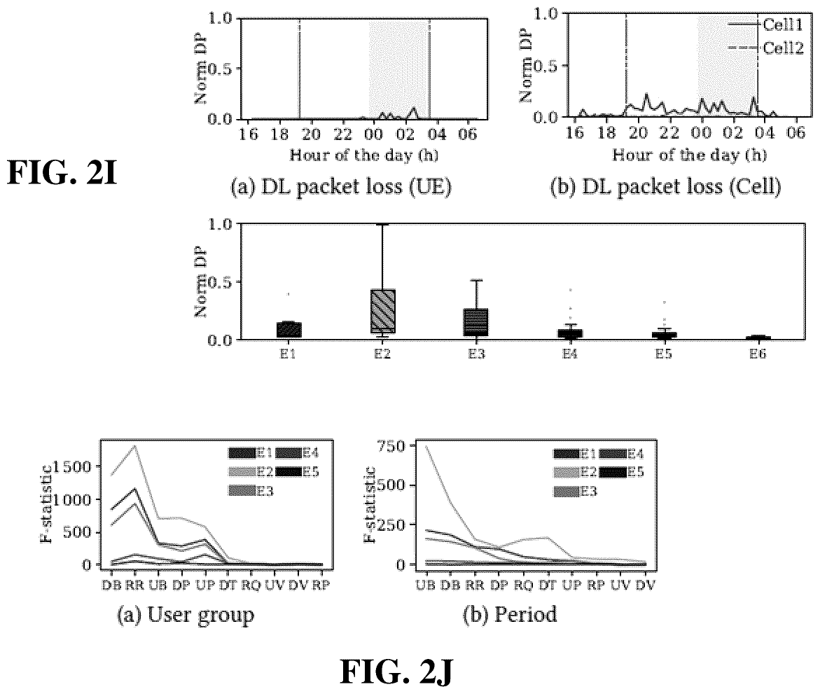

FIG. 2A is a block diagram illustrating an example, non-limiting embodiment of a cellular network 200 functioning within the communications network 125 of FIG. 1 in accordance with various aspects described herein. In particular, FIG. 2A illustrates an inference solution that uses a small number of reported users who reported a network outage via customer care calls to infer many silent users who are also impacted by the outage in a cellular network 200.

The cellular network 200 may correspond to the wireless access 120 of FIG. 1. The cellular network generally includes a number of base stations or cell towers providing mobile communications services to subscribers in areas served by the cell towers. The cellular network may form an access network served by a core network which implements additional functionality such as mobility management, billing and other processing as well as providing communication access to other networks including the public internet.

In the exemplary cellular network 200, a network outage has occurred at a cell tower 202. Other cell towers of the cellular network include unimpacted towers 204, which are not impacted by the outage and continue to operate normally, and impacted towers 206 which are impacted by the outage and are non-function or only partially functional. Subscribers in areas served by the cell tower 202, the locus of the outage, and the impacted towers 206, may experience interruptions or limitations in their service from the cellular network.

The cellular network 200 provides communication services to a number of subscribers or users equipped with user equipment (UE). The total group of users includes reported users 208 who are impacted by the outage and have reported the outage. For example, the reported users have contacted the customer care facility of the operator of the cellular network (referred to as “care”) to report the outage, request assistance, or both. Calls to care (which may be referred to as care calls) or other interactions with care may be logged and data related to the care calls may be logged and processed for insight about the outage, the users and the network.

The total group of users in this example further includes impacted users 210 and unimpacted users 212. The impacted users 210 have experienced an interruption in service or reduction in service due to the outage but have not reported that to care. The unimpacted users 212 have not experienced any interruptions or reduction in service due to the outage. The impacted users 210 and the unimpacted users 212 may be called collectively silent users. Not all users and not all cell towers are labelled in FIG. 2A so as to not unduly complicate the drawing figure. The subscribers or users accessing the cellular network 200 in FIG. 2A may include an unknown number of internet of things (IoT) devices which may be impacted by an outage but generally do not include an ability to report the outage to the network.

In general, relatively few users report an outage when the outage occurs or report the negative impact of the outage on the users' service. The majority of impacted users remain silent users to the network operator. Thus, it becomes necessary to infer which users are impacted by the outage. Information about the silent users may be inferred from information about the reported users 208.

In operational cellular networks, service issues at cell towers are difficult to avoid. A cell tower might completely or partially go out of service for various reasons including power failures, disasters, software updates, system maintenance, etc. Further, just a portion of a cell tower may go out of service, such as one 120-degree sector or face of the tower's service area. Not all service issues impact users because of a degree of resilience built into the cellular network. During a service issue, which may be referred to as an outage, which does impact nearby users, some users may be significantly impacted compared to other users in the same area. It is therefore vital for the operator of the cellular network to understand which users are impacted by an outage. This information can be used, for example, to prioritize repairs in an area with severely impacted users and to inform impacted users about the outage.

It is an important but difficult task for the network operator to identify all impacted users. Generally, very few users report or complain about their negative impacts during cellular network outages. The majority of impacted users stay silent to the network operator. By distinguishing which mobile or IoT users are truly impacted by network outages, regardless of a call customer care, the cellular provider can be more proactive to predict outages, mitigate the issue, and communicate with the customers who are impacted.

The noted problem is also critical and more challenging for IoT device, such as connected vehicles. Specifically, IoT users are usually the silent customers who typically do not complain about the service upon experiencing service issues. Therefore, it is more important to understand their service impact in a more proactive way. In addition, the IoT devices using the traffic and the mobility feature of IoT devices are generally very diverse in nature, which makes profiling these devices more challenging.

In conventional systems, it has been known to target on classifying whether a customer who calls in Care and complains about the service is impacted by network outages. This is a relatively reactive approach. To date, there has been no effort to identify the majority of users who suffer from the outage but do not call care.

FIG. 2A illustrates a system and technique for inferring silent users who are impacted by an outage in the cellular network 200. A straightforward approach is to use machine learning techniques to infer who are impacted based on big data collected by the network operator. In the inference stage, a UE service quality profile is created using an identified set of KPIs/KCIs. Then the pretrained model is leveraged to classify if a UE is impacted or not.

Thus, in a method 220, in a first operation 222, the network operator, monitoring and manage network operations, collects a large number of key performance indicators (KPIs) and key capacity indicators (KCIs) per cell and per user equipment (UE). A KPI may be an indicator related to service quality and a KCI may be an indicator to show how well the bin is covered. KPIs and KCIs may be referred to collectively herein as KPIs for simplicity.

Any suitable KPIs or KCIs can be collected, stored and processed. In an example, KPIs cover all key factors such as runtime traffic loads, radio coverage, performance, reliability including packet loss and failures or abnormal events, and so on. In one or more embodiments, KCIs may relate to load on a system or system element, such as an expected transaction capacity. In various embodiments, KCIs may include Transactions Per Second (TPS), Fill Capacity (e.g., total number of available entries), or other defined values for the system itself, such as minimum number of peers, redundancy state values, etc. Normal operation of the cellular network generates such KPIs and KCIs in call detail records and other information.

In a second process 224, the network operator monitors customer care calls where some impacted users report their poor experience during an outage. This subset of impacted users, or reported users 208, can be even treated as a ground truth reference to supervise training a model and, in third operation 226, to infer other impacted users 210 who are silent to the network operator.

In some respects, the task is much harder than anticipated, due to three technical challenges. First, very few impacted users report the outage, and the majority stays silent during an outage event. The number of reported users is very limited, typically two or three orders of magnitude smaller than the silent ones. Second, the feature space is huge with a wide variety of KPIs and a large volume of KPI data. Simply applying the well-known learning models with many features are prone to overfitting with limited (insufficient) ground truth from reported users. Third, the diversity of outage events aggravates the situation. Outages often result in unplanned consequences due to various causes and thus their impacts vary substantially.

In accordance with various aspects described herein, a system and method infer silent users impacted by outage events using hints gained from very limited reported users. The system and method make a lightweight and effective inference which can accurately detect impacted users in various outage events. First, the system and method characterize KPI patterns of reported users in outage instances and gain hints to identify a small subset of KPIs needed for detecting impacted users. Second, based on the quantitative analysis, the system and method further employ domain expertise to develop a preliminary learning-based solution. Additional remaining challenges are considered and new design insights presented to enhance the proposed solution inference. Several challenging cases of impacted users are considered, particularly users who suffer with short-term degradation, mild impacts and even disconnections with un-observable impacts.

Initially, data traces collected from a major US cellular service operator are used to study what KPIs are important to detect impacted users in outages. A solution of inferring impacted users is presented which addresses the two challenges of limited reported users and huge feature space.

FIG. 2B depicts an illustrative embodiment of a method 230 in accordance with various aspects described herein. The method 230 may be performed on any suitable data processing such as a server operational in a core network associated with a mobility network such as cellular network 200. The method 230 may be initiated in any suitable manner such as after the occurrence of an outage in a portion of the cellular network 200 in response to a desire to identify all users affected by the outage and to protect against future outages.

At step 232, critical KPIs are identified for the outage. Any suitable technique or data processing may be pursued to identify the key performance indicators of reported users that, for example, correlate with outages in the cellular network 200. In one embodiment, an exemplary dataset containing 30 outage instances in a particular time frame is used. A single outage instance may be defined as at least one cell on a cell tower ceasing to provide services to all users for more than 1 hour. Note that each physical cell tower deploys many cells running over different frequency channels and along directional antennas. For each outage instance, data gathered from the outage cells as well as the neighboring cells are considered, because the outage impact can spread to neighboring cells. This can occur due to, for example, offloading to neighboring cells resulting in congestion and even out-of-service conditions at the neighboring cells. The cell level information includes the geo-location, traffic load and cell-level KPIs such as accessibility and retainability.

To study the outage impacts on users, anonymized data from UE such as mobile phones may be considered in the vicinity of the outage cells. There are hundreds of UE-level KPIs available. Table 1 shows ten exemplary KPIs closely related to the outage impacts based on the domain knowledge. Other KPIs may be evaluated as well as the ten listed in Table 1.

TABLE 1

| | Description | Unit |
|---|---|---|
| DT | DL (downlink) throughput | Mbps |
| DV | DL data volume | MB |
| UV | UL (uplink) data volume | MB |
| DP | DL packet loss rate | % |
| UP | UL packet loss rate | % |
| DB | DL Block Error Rate (BLER) | % |
| UB | UL Block Error Rate (BLER) | % |
| RR | Abnormal RRC Release Rate | % |
| RP | Reference Signal Received Power (RSRP) | dBm |
| RQ | Reference Signal Received Quality (RSRQ) | dB |

In the exemplary embodiment, these UE-level KPIs are aggregated at 15-minute intervals. Further, for each UE, the KPIs collected from 3 days before the outage to 3 days after the outage are used. Also, customer care calls from all nearby users are correlated with the outage instance and reported users are identified who have called customer care reporting their service issues within three days after the start time of the outage event and used as the ground truth of impacted users. In the exemplary dataset, these reported users account for only 0.2% of all users in the vicinity of outage cells.

Reported users are used as the ground truth to characterize the KPIs patterns of impacted users and thus to identify a small subset of KPIs critical for detecting impacted users. Review of the KPIs reveals that only a subset of KPIs exhibit significant patterns during outage instances, which can be used to detect impacted users. For each KPI, its distribution over the reported users from all outage events may be compared along with the distribution over normal users in a different but similar region without any outage events.

FIG. 2C shows a comparison of selected KPIs observed with reported users (impacted) and normal users from three days before outage to three days after outage. In FIG. 2C, a “−” sign indicates time before an outage and a “+” sign indicated time after an outage. The illustrated KPIs downlink (DL) packet loss rate (DP) and reference signal received power (RSRP or RP). Both DP and RP values are normalized in the drawing figure.

In FIG. 2C, it can be observed that the DP of impacted users surged during the outage (FIG. 2C(a)), and immediately returned to normal level after the outage ended. By contrast, RP only exhibited a slight decrease during the outage. The RP distributions for reported or impacted users and normal or nonimpacted users largely overlap, so RP cannot serve as a representative feature to detect impacted users. Other KPIs exhibit various pattern changes between impacted users and normal users. Therefore, it is necessary to select those critical KPIs which show significant pattern changes during outage as the input of a lightweight model.

The importance of each KPI may further be quantified through comparison across different time periods and user groups. The set of key KPIs may then be identified for detecting impacted users. In an example, this may be done using an Analysis of Variance (ANOVA) test, a statistical test commonly used to detect differences between two sets of data, to quantify the difference of each KPI. Differences may be detected, first, between impacted users and normal users, and second before outage and during outage. The KPIs with higher F-statistics have greater differences between the two groups of KPI samples, so they are more distinguishable for impacted user detection. An F-statistic is a ratio of two variances. Variances measure the dispersal of the data points around the mean.

FIG. 2D shows statistics between different user groups and different periods for an outage in a cellular network. FIG. 2D shows the overall importance of each KPI represented by F-statistics in our dataset. Among the KPIs considered, downlink block error rate (BLER, DB), abnormal radio resource control release rate (RR), uplink block error rate (UB) and downlink packet loss rate (DP) are the top four KPIs with highest F-statistics. On the contrary, KPIs related to data usage such as downlink throughput (DT), downlink data volume (DV) and uplink data volume (UV) are less important. This may be because these KPIs are also significantly influenced by user behaviors such as usage patterns, making them highly diverse in both outage scenarios and normal scenarios. KPIs related to radio quality such as RP and reference signal received quality (RSRQ, RQ) are largely decided by user mobility, so distinct patterns are barely observed during the outage. All KPIs can then be ranked in each outage instance based on their F-statistics.

FIG. 2E shows the ranking of each KPI in each outage instance based on F-statistics. FIG. 2D shows that DB, RR, UB and DP are still the top four KPIs in most outage instances. However, DB, RR, UB and DP are not the most important in a small portion of outage instances as shown in FIG. 2D. This may be due to the diversity of outage instances, analyzed below. In a nutshell, in the exemplary embodiment, these four KPIs are most critical for detecting impacted users, and they may be used as signatures for detecting impacted users.

Using critical KPIs identified in Table 1, a learning-based solution operates to detect impacted users. Referring again to FIG. 2B, the method 230 continues at step 234 with the preparation of three datasets. A first data set includes a reported user dataset, which includes users who experienced the outage and contacted customer care within three days of the outage start time. A second dataset includes an unimpacted user dataset, comprising users in other regions or time windows without any outage. A third dataset includes a silent user dataset for those who were close to an outage but did not contact customer care within three days after the outage started. An example embodiment includes only about 1,000 reported users as the ground truth and requires inference of over 50,000 silent users.

In embodiments, at step 236 features may be constructed using critical KPIs identified in Table 1, or any other suitable KPIs. In an example, with the identified top four KPIs, 27*4 features are generated using a tool such as tsfresh which can automatically generate time series features. These features include the mean, maximum, and variance values of each KPI during outage, as well as the gap and ratio of KPIs before and during outage. Considering the limited scale of datasets with reported users for the exemplary embodiment, the top-K (where K=10 in an example) are further selected through the importance testing to avoid overfitting.

At step 238, the model is trained using a mixture of reported users and silent users. In the model training phase, an inference model is built and trained on reported and unimpacted user datasets. In one embodiment, the XGBoost model is selected as the learning model. XGBoost is known for delivering high performance and accuracy in various machine learning tasks. Moreover, XGBoost can effectively handle missing and sparse data, which is especially valuable in handling cellular data. Any other suitable model may be selected in other embodiments. In the example, the reported users and unimpacted users are mixed together, and divided into training and testing datasets with a 7:3 ratio to train the model.

At step 240, the trained model is applied to the silent user dataset to infer impacted users. The result may be a list of impacted users or potentially impacted users, with a probability of impact or other statistical analysis.

At step 242, reports are generated identifying users and providing additional information to the network operator. The network operator may use the model output to identify users affected by the outage and to take corrective action. In one example, the network operator may credit the accounts of subscribers who were affected by the outage including both reported subscribers and silent subscribers, to account for the time the cellular network and service were not available.

Another example relates to connected vehicles. A connected vehicle is a vehicle that can communicate bidirectionally with other systems outside the vehicle, such as other connected vehicles, in part using a mobility network such as cellular network 200. For connected vehicles, the network operator can use the results of the method 230 to forecast a service degradation of a future destination of a connected vehicle, based on the KPI/KCI profiles. The network operator can then communicate a notification to the user or the connected vehicle. In this manner, the user can make preparation ahead or choose an alternate route. In connected vehicles with onboard navigation systems, this information may be provided to the route mapping system to automatically identify the upcoming network service degradation, select the alternative route and advise the vehicle operator accordingly. For autonomous vehicles, the information about the upcoming degradation may be provided to the automatic vehicle routing system which selects a route and steers the vehicle and may react accordingly. In some other examples, the network may vary or limit which base stations a mobile user such as a connected vehicle is handed off to as the mobile user approaches an outage site. By handing off communications for the mobile user to nonaffected sites only, the network operator ensures that the mobile user remains in contact with network and is not affected by the outage. For connected vehicles, which rely on a mobility network for communication with other connected vehicles, awareness of a local network outage is essential to save and reliable operation.

Further, the network operator may take steps to modify the network or portions of the network where the outage occurred, based on the information produced by the method 230. For example, the network may be modified to provide increased redundancy so that fewer subscribers will be affected in the event of a similar outage in the future. The network operator may add additional cell towers or other network components, or segment the network into smaller cells to increase capacity and reduce susceptibility to future outages. In some cases, mobile cell towers may be dispatched to provide network service for a time when an outage is detected or predicted.

Further, by correlating the impacted UE/cell service profile with the known physical events, such as planned maintenance work, forecasted natural disasters or power outages, the network operator can better estimate the service impact of future events on individual customers. Based on this prediction, the network operator may send proactive notification messages to the customers or help the customer to mitigate the impact in advance. In one example, the network operator may send a text message or other communication recommending use of Wi-Fi calling for the customer for a time.

Still further, network operator may use the information from method 230 during maintenance work. From time to time, the network operator needs to disable a portion of the cellular network 200 for maintenance, network improvements, etc. Before the work is performed, the network operator would like to know how this planned outage will affect users. This includes knowing in detail what users including IoT users will be impacted. Knowing the population of the impacted area is useful but knowing the number and types and activities of the impacted users in the area may be much more useful. Further, after the scheduled outage is completed, the network operator would like information about what users were, in fact, impacted by the outage. This can aid in future planning, scheduling and performance of such work.

Exemplary evaluation results indicate that the method 230 can detect the majority of impacted users. FIG. 2F shows KPIs of impacted (imp.) and unimpacted (unimp.) users through report (rep.) or inference (inf.). FIG. 2F shows the (normalized) KPI trajectories of the reported and inferred users from all outage events in the whole dataset. It is apparent that the KPI patterns of inferred and reported impacted users are very close. For both inferred and reported impacted users, their DP and DB KPIs are boosted during outage, although the amplitude of reported users is slightly higher. This indicates that the method 230 achieves a high precision in inferring impacted users.

Detailed evaluation statistics of the method 230 are presented in classification and inference tasks for both all outage instances and representative instances in Table 2.

TABLE 2
Information of example outage events.

| | Outage | Outage | Neigh. cell | Neigh. cell | Reported |
|---|---|---|---|---|---|
| | duration | level | density | impacted | user (%) |
| E1 | Short | Complete | Sparse | Majority | 0.3% |
| E2 | Long | Complete | Sparse | Majority | 0.5% |
| E3 | Long | Complete | Sparse | Minority | 0.2% |
| E4 | Short | Complete | Sparse | Minority | 0.2% |
| E5 | Short | Complete | Dense | Minority | 0.1% |
| E6 | Short | Partial | Dense | Minority | 0% |

TABLE 3
Evaluation results of the proposed solution on classification
of reported users and inference of silent users. P, R and
F1 represent precision, recall and F1 score respectively

| | Classification | | | Inference | | |
|---|---|---|---|---|---|---|
| | Accuracy | | | Inference of | D-statistic | D-statistic |
| | P | R | F1 | impacted users | (impacted) | (unimpacted) |
| All | 93% | 90% | 91% | 31.7% | 0.21 | 0.23 |
| E1 | 100% | 96% | 98% | 50.0% | 0.19 | 0.26 |
| E2 | 98% | 98% | 98% | 67.9% | 0.18 | 0.18 |
| E3 | 99% | 90% | 94% | 30.8% | 0.22 | 0.23 |
| E4 | 93% | 90% | 91% | 31.9% | 0.31 | 0.21 |
| E5 | 92% | 75% | 83% | 16.4% | 0.25 | 0.18 |
| E6 | N/A | N/A | N/A | 12.7% | N/A | 0.21 |

Table 3 presents evaluation results. The first row (All) in Table 3 shows the overall accuracy across all studied outage events. The in-depth study on six examples is discussed below. Specifically, the results shows 93% precision and 90% recall when classifying the reported impacted users against the unimpacted users for the labeled data. In the inference of unreported users (unlabeled data), 31.7% of users in the impact zones of outage events are inferred as impacted users. The Kolmogorov-Smirnov test (K-S test) may be used to quantify the difference in KPIs between reported and inferred users and use the average value of D-statistics output by K-S test of the set of KPIs as the metric to evaluate the accuracy of inference. The D-statistics between reported and inferred impacted users is 0.21, which means that the KPI gap is small between reported and inferred users. It proves that embodiments of the disclosed method and system can achieve a good accuracy in impacted user inference.

Embodiments of the method 230 can effectively address two challenges, including a challenge posed by limited reported users and a challenge posed by a huge feature space. The solution of method 230 presents a lightweight inference to detect silent impacted users based on reported users. However, the method 230 must also address a third challenge, that of outage diversity. The types of outages that can and do occur in a mobility network such as cellular network 200 are many in number.

Table 2 shows six representative outage instances used, labeled E1 through E6. An outage instance may be categorized in terms of its duration, outage level, neighboring cell density, and the ratio of impacted cells in the vicinity. The outage is considered a short instance if it lasts fewer than 6 hours. Otherwise, it is a long outage which can extend to several days.

The outage level is the ratio of failed cell sectors over all the cells at the same cell tower. The cell tower can completely fail or partially fail. The ratio of impacted neighboring cells is the ratio of failed cell sectors on all neighboring cell towers, where neighboring cell towers are defined as the ten nearest cell towers to the outage tower because the impact of an outage event rarely extends far. Generally, cellular network operators execute automatic traffic load-balancing policies to mitigate the impact of outages by off-loading the traffic from the cell sectors impacted by the outage to neighboring, eligible cell sectors. Where multiple eligible cell sectors are available, cellular providers are able to effectively manage the outage, limiting its impact on users. However, given various population density and traffic volume, the density of neighboring cells varies substantially. As a result, an outage often impacts a different portion of neighboring cells depending on high or sparse cell density, thereby posing disparate (and often unpredictable) impacts on users.

Six representative instances are selected as follows. Most neighboring cells (majority) are out of services in E1 and E2, while most are still in service in E3, E4 and E5. Thus, it is expected to see more severe outage impacts in E1 and E2. In addition, back-up cells are abundant in E5, but are limited in E3. E6 is the mildest instance as the outage cell tower is not completely out of service. Notably, users rarely report their service issues. Even in the worst outage instance (here, E2), only 0.5% of users reported the service issue. This percentage seems to decrease as the impact severity goes down. In E6, there are even no reported users. Therefore, collecting ground truth is even rarer in specific outage instances.

Thus, in outage instances with less severe user impact, it becomes challenging to detect impacted users and the solution of method 230 does not achieve highest accuracy. Table 3 lists the accuracy of our solution for E1-E6. In classification of reported users, the solution achieves over 97% precision and recall in E1 and E2. As the impact severity of outage decreases, up to 25% of impacted users can not be identified. For inferred silent impacted users, with decreasing impact severity, the D-statistics increases from 0.18 to 0.31, indicating that the difference between inferred impacted users and reported users significantly widens. There are three main cases where the solution is less than optimal at detecting impacted users. These cases include transient user impact, disconnected UE, and indirectly impacted UE.

Transient user impact. The user activity and handoff largely determine the duration of outage impact. However, both factors may be overlooked in some embodiments of the solution of method 230. When users are served by outage cells for a short period due to handoff, brief KPI degradation significantly increases the difficulty of detection.

FIG. 2G illustrates short term user impact due to an outage in cellular network 200. FIG. 2G shows a short-term impacted user in E3 not detected by method 230 due to handoff. UE-level KPIs (e.g., normalized DL packet loss shown in FIG. 2G(a)) only show a very brief degradation (15 minutes between 20:15 and 20:30) and are at normal levels rest of the time. In this example, the user is served by two cells during outage: Cell 1 is a major back-up cell with severe KPI degradation during outage, while Cell 2 is not impacted.

FIG. 2G(b) shows the (normalized) average DL packet loss rate of all users served by Cell 1 and Cell 2. Cell 1 has dramatic increase in DL packet loss during the whole outage duration, while DL packet loss on Cell 2 remains at normal level. This user is served by Cell 1 for only 15 minutes between 20:15 and 20:30 and served by Cell 2 during the rest of outage duration. It explains why only a very brief degradation was observed from this UE's KIPs during the outage.

The transient user impact scenarios are commonly observed in outage events. For example, FIG. 2G(d) shows the duration ratio of each reported impacted user served by outage cells in event E1-E5. In all example events except E4, 21%-42% of impacted users are served by outage cells for only <10% of outage duration. Moreover, the impacted duration ratio is lower than 5% for 66.7% of impacted users missed by the embodiment of method 230. This indicates that accurately detecting transient user impact is challenging for this embodiment of method 230.

To detect transient user impact, a feasible approach is to do pattern matching of UE KPIs and serving cell KPIs to infer whether a transient KPI degradation is caused by serving cell hand off. If the user KPIs mainly degrade during the period served by the outage cell and remain at a normal level when served by other cells, the brief KPI degradation is very likely to be caused by the outage events. As UE is served by one specific cell at any given timestamp, the KPIs of serving cells may be consolidated at each timestamp into a single KPI series. FIG. 2G(c) presents the consolidated DL packet loss rate for the undetected impacted users. The surge of packet loss rate can be observed in user KPI and consolidated serving cell KPI occurs simultaneously. Therefore, the user KPIs and cell KPIs can be correlated to determine whether the short-term KPI degradation is caused by outage or service dynamics.

Disconnected UEs. When the majority of neighboring cells are impacted by an outage, UEs can be forced to disconnect from the network as they are unable to find available cells. However, it is difficult to distinguish involuntarily disconnected UEs due to service issues from UEs that voluntarily release connection due to inactivity.

FIG. 2H illustrates user impact for a disconnected user during an outage in a cellular network. FIG. 2H shows such a missed impacted user in E2. From the (normalized) packet loss rate shown in FIG. 2H(a), this UE seems to have similar patterns as the UE in FIG. 2G(a) that only experiences brief (15 minutes) KPI degradation. However, the actual impact time of this UE is much longer than 15 minutes. When the outage event started at 21:15, the UE is disconnected from the outage cell and loses network connectivity. Worse still, the UE is not able to find any available cells to restore the network connection until 22:45. Consequently, it can be seen see that the throughput and packet loss data are missing during this period (area 250 in FIG. 2H(a) and FIG. 2H(b)).

The usage pattern of each user can be profiled utilizing historical data, for example, using control plane signaling messages such as service requests. This can help distinguish involuntarily disconnected UEs from UEs that voluntarily release connection due to inactivity. By examining the UE's historical data before outage, the level of activity of the UE can be inferred. FIG. 2H(c) presents the UE's (normalized) DL throughput from five days before outage to the end of outage. The area 252 represents the same time period (21:15 to 22:45) every day before outage. We can observe that before outage, the UE is active during this specific period every day. This indicates that it is highly unlikely for the user not to use network services during this period on the day of outage. Therefore, it can be inferred that the user is disconnected from network due to the outage.

Indirectly impacted UEs. In an outage event, some (if not all) UEs served by the outage cell migrate to neighboring cells. As a result, one or more neighboring cells may experience degrading service due to higher traffic load, and thus indirectly impact UEs originally served by these neighboring cells. These indirectly impacted UEs often have minor KPI degradation. The severity of KPI degradation depends on a number of factors including user population, cell density, traffic load, etc., and can vary significantly.

FIG. 2I illustrates indirectly impacted users during an outage in a cellular network. FIG. 2I exemplifies such a missed indirectly impacted UE in E3. This UE is served by a neighbor cell of the outage event from 23:45 to 3:00. During this period, the (normalized) packet loss rate of the UE does increase (FIG. 8a), but the magnitude is much smaller compared to other impacted UEs, such as the UE shown in FIG. 2G(a). This is because the serving cell of this UE is only slightly impacted by the outage event. FIG. 2I(b) shows the (normalized) average packet loss rate of all UEs served by this cell. It can be observed that UEs experience slight increase in packet loss rate. FIG.2I(c) further presents the (normalized) average packet loss rate of all neighboring cells in event E1-E6. Cells in severe outage events (E1-E3) are usually impacted to a much greater extent than cells in less severe outage events (E4-E6). Consequently, the impact of UEs in less severe outage events is insignificant and hard to be detected. That may produce lower accuracy in some embodiments of method 230 in these less severe events.

In addition, the milder user impact also reduces the importance of critical KPIs in less severe outage events. In outage events with severe user impact, the KPIs have higher F-statistics and are ranked higher in importance. Conversely, in less severe outage instances, the gap of F-statistics between key KPIs and other KPIs narrows, so their importance decreases.

FIG. 2J illustrates F-statistics in ANOVA in example outage events between different groups and periods. FIG. 2J shows the F-statistics of each KPI in E1-E5 (E6 is omitted due to no reported user). As introduced before, the user impact severity of outage instances E1 to E5 gradually decreases. In E1, E2 and E3, the F-statistics of all four key KPIs (DB, RR, UB and DP) are over 200 in inter-user group comparison (FIG. 2J(a)), higher than most of other KPIs. However, their F-statistics dramatically drops to 40-150 in E4 and <50 in E5, with a much smaller gap with other KPIs. The same phenomenon can be observed in the comparison between different periods (FIG. 2J(b)).

By aggregating and analyzing the performance of users served by each cell, the patterns of user KPIs in each cell can be profiled. Through clustering cells with similar patterns, differentiated models on cells with varied degree of outage impact can be adopted.

In accordance with the system and methods described herein, a network operator can forecast the potential users who may call customer care because of a known network service problem. Therefore, the network operator can send automatic notification messages or credits to these users and prevent potential customer care calls, which will help to significantly reduce the overhead to call centers of the network operator. With more precise impacted user identification, only the customers who are truly affected by outages can receive the credit. This can help to optimize how the credits are given back to customers. By proactively resolving or mitigating the customer's service issues without waiting for customer complaints, customer satisfaction rate may increase, and the churn rate may decrease. Other benefits will accrue to the network operator and customers as well.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

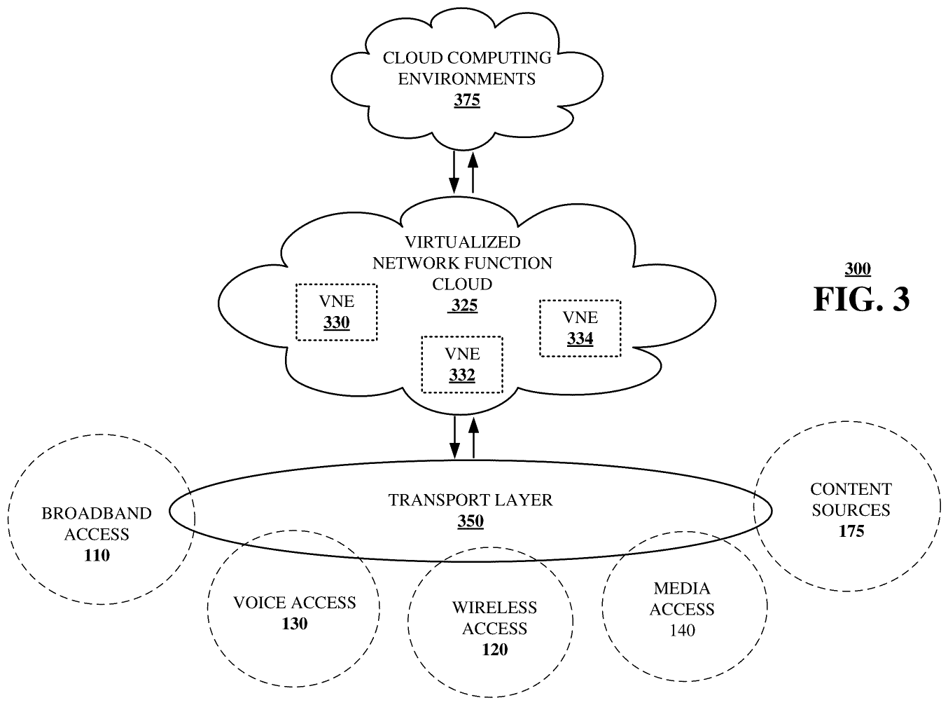

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of cellular network 200 and method 230 presented in FIG. 1, FIG. 2A, FIGS. 2B, and 3. For example, virtualized communication network 300 can facilitate in whole or in part collecting outage data for a network service outage and inferring users who do not report the service outage based on information about reported users who do report the service outage.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

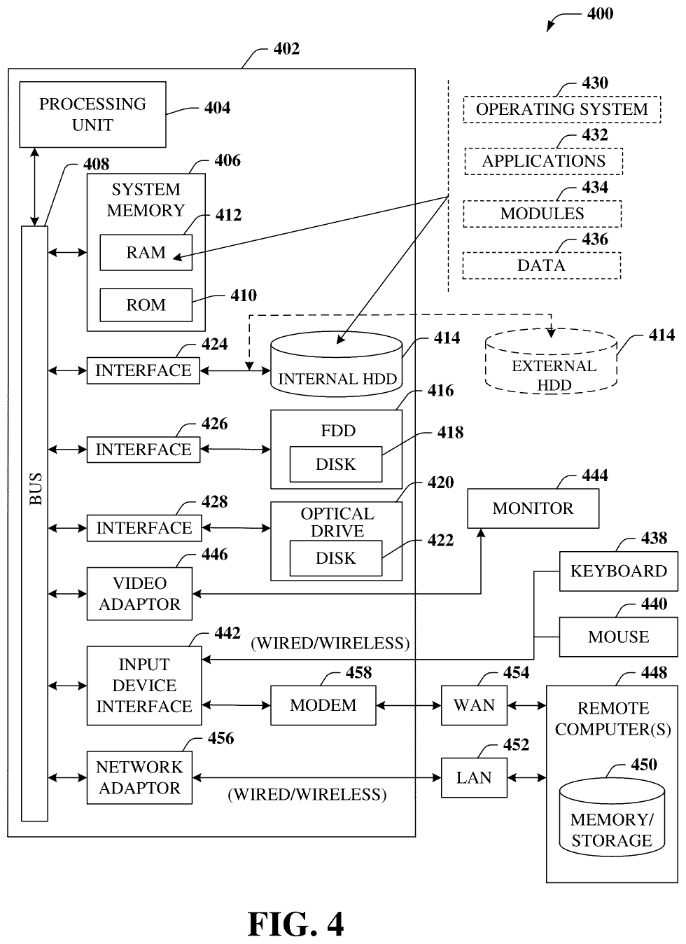

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part collecting outage data for a network service outage and inferring users who do not report the service outage based on information about reported users who do report the service outage.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

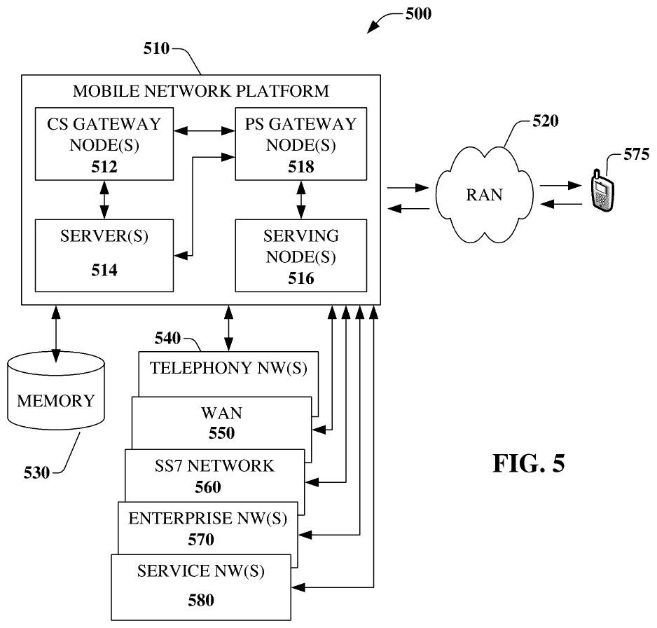

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part collecting outage data for a network service outage in a mobility network or radio access network and inferring users who do not report the service outage based on information about reported users who do report the service outage. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors

configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

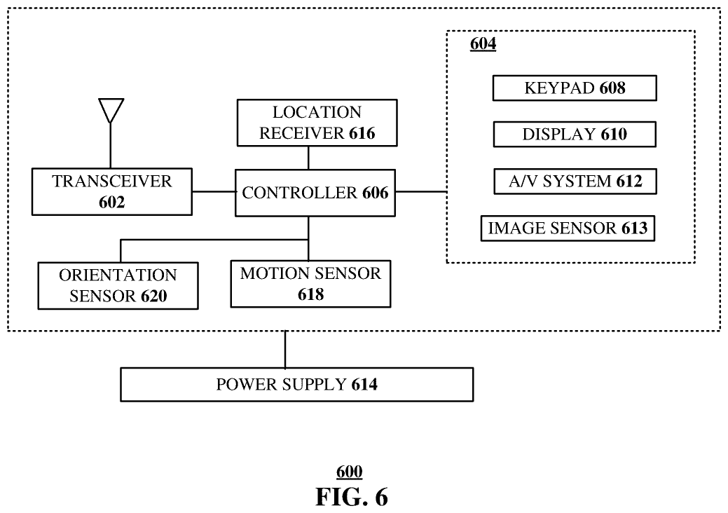

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part collecting outage data for a network service outage and inferring users of communication devices such as communication device 600 who do not report the service outage based on information about reported users who do report the service outage.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving outage data about service issues including a service outage in a mobility network, the service outage affecting a plurality of affected users of the mobility network, the plurality of affected users including reported users;
identifying, in the outage data, patterns about the reported users;
inferring impacted users of the mobility network based on the patterns about the reported users, the impacted users including users who experienced the service outage but did not report the service outage; and
modifying the mobility network based on the impacted users.

2. The device of claim 1, wherein the modifying the mobility network comprises:
identifying a portion of the mobility network associated with severely impacted users or with a relatively high number of impacted users, forming an impacted portion of the network; and
prioritizing repairs in the impacted portion of the mobility network.

3. The device of claim 1, wherein the identifying patterns about the reported users comprises:
identifying, in the outage data, one or more key performance indicators (KPIs) that are most affected by the service outage;
identifying, in the outage data, silent users, forming a silent user dataset;
building an inference model based on the one or more KPIs;
applying the silent user dataset to the inference model; and
inferring the impacted users from the inference model.

4. The device of claim 3, wherein the identifying one or more KPIs that are most impacted by the service outage comprises:
for each KPI of the one or more KPIS, comparing a first distribution of the KPI over the reported users for the service issues in the outage data with a second distribution of the KPI over users in a similar region with no service issues;
identifying, in the outage data, critical KPIs that show significant pattern changes during the service outage.

5. The device of claim 3, wherein the forming the silent user dataset comprises:
identifying, in the outage data, users who were physically close to the service outage but did not report the service outage.

6. The device of claim 5, wherein the forming the silent user dataset further comprise:
identifying users who were physically close to the service outage but did not contact a customer care resource of the mobility network within a predetermined time after the service outage.

7. The device of claim 6, wherein the operations further comprise:
identifying, in the outage data, users who experienced the service outage and contacted the customer care resource of the mobility network within the predetermined time after the service outage, forming the reported users.

8. The device of claim 1, wherein the operations further comprise:
identifying an area associated with a current outage;
identifying a nonimpacted user traveling toward the area associated with the current outage; and
providing a notification to the nonimpacted user to enable the nonimpacted user to avoid the area associated with the current outage.

9. The device of claim 8, wherein the nonimpacted user is associated with a connected vehicle.

10. The device of claim 1, wherein the operations further comprise:
identifying an area associated with a current outage;
identifying a nonimpacted user traveling toward the area associated with the current outage; and
limiting handoffs of communication by the nonimpacted user and the mobility network to avoid the area associated with the current outage.

11. A non-transitory machine-readable medium, comprising executable instructions that, when executed by a processing system including a processor, facilitate performance of operations, the operations comprising:
receiving outage data related to service issues including a service outage in a mobility network, the service outage affecting a plurality of affected users of the mobility network, the plurality of affected users including reported users known to be affected by the service outage;
identifying, in the outage data, critical key performance indicators (KPIs) associated with the service outage;
identifying, in the outage data, silent users not impacted by the outage, forming a silent user dataset;
building a model based on the critical KPIs;
applying the silent user dataset to the model; and
inferring impacted users based on output of the model, the impacted users including users of the mobility network who experienced the service outage but did not report the service outage.

12. The non-transitory machine-readable medium of claim 11, wherein the identifying critical KPIs comprises:
comparing KPIs for affected users who are affected by the service outage with KPIs for non-affected users who are not affected by the service outage; and
selecting, as the critical KPIs, one or more KPIs for affected users which vary most from same KPIs for non-affected users.

13. The non-transitory machine-readable medium of claim 12, wherein the identifying critical KPIs further comprises:
quantifying importance of each KPI of the KPIs for affected users across two or more different time periods and two or more different user groups; and
selecting as the critical KPIs based on the quantifying.

14. The non-transitory machine-readable medium of claim 11, wherein the operations further comprise:
forming an unimpacted user dataset based on users of the mobility network at locations not affected by the service outage or at times not affected by the service outage;
forming a reported user dataset based on users of the mobility network who were affected by the service outage and who reported the service outage; and
training the model using the unimpacted user dataset and the reported user dataset.

15. The non-transitory machine-readable medium of claim 11, wherein the operations further comprise:
crediting subscribers accounts of the impacted users.

16. The non-transitory machine-readable medium of claim 11, wherein the operations further comprise:
advising a mobile user not impacted by a current outage and traveling toward an area associated with the current outage to enable the mobile user to avoid the area associated with the current outage.

17. A method, comprising:
receiving, by a processing system including a processor, outage data related to service issues including a service outage in a mobility network, the service outage affecting a plurality of affected users of the mobility network, the plurality of affected users including reported users known to be affected by the service outage;
identifying, by the processing system, in the outage data, critical key performance indicators (KPIs) associated with the service outage;
building, by the processing system, an inference model based on the critical KPIs; and
inferring, by the processing system, silent users based on output of the inference model, the silent users including affected users who are not reported users.

18. The method of claim 17, wherein the identifying the critical KPIs comprises:
receiving, by the processing system, KPI data for impacted users who experienced the service outage;
characterizing, by the processing system, the KPI data for the impacted users using the reported users as ground truth, forming KPI patterns; and
identifying, by the processing system, the critical KPIs based on the KPI patterns.

19. The method of claim 17, comprising:
training, by the processing system, the inference model using information about the reported users and information about unimpacted users who are not impacted by the service outage.

20. The method of claim 17, comprising:
crediting, by the processing system, subscriber accounts of the silent users to compensate for a lack of service during the service outage.
